(19) United States
(12) Patent Application Publication
(10) Pub. No.: US 2006/0174273 A1
(43) Pub. Date: Aug. 3, 2006

(54) Method of displaying service in DMB, and method and apparatus for managing preferred service

(75) Inventors: Hyun-cheol Park, Suwon-si (KR); Dong-seok Kim, Suwon-si (KR); Eun-hee Park, Suwon-si (KR); Keun-mi Song, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/260,203

(22) Filed: Oct. 28, 2005

(30) Foreign Application Priority Data
Nov. 20, 2004 (KR) 10-2004-0095536

(51) Int. Cl. H04N 5/445; G06F 13/00; G06F 3/00

(52) U.S. Cl. 725/41; 725/40; 725/37; 725/60

(57) ABSTRACT

A method and an apparatus are provided for displaying ensembles and services provided by digital multimedia broadcasting (DMB) so that a user can search for and select a desired service, and can determine, register, and manage a preferred service according to the user's inclination for watching TV. The method relates to displaying a broadcast program schedule provided by a digital multimedia broadcasting, and includes displaying ensembles included in the broadcast program schedule on a first window of a screen, and displaying services linked to each of the ensembles on a second window of the screen. Accordingly, it is possible for the user to easily view and select ensembles and services provided by DMB.

### CROSS-REFERENCE TO RELATED APPLICATIONS

This application claims priority from Korean Patent Application No. 10-2004-0095536, filed on Nov. 20, 2004, in the Korean Intellectual Property Office, the disclosure of which is incorporated by reference herein in its entirety.

### BACKGROUND OF THE INVENTION

1. Field of the Invention

The present invention relates to a method of providing a user with ensembles and a service program schedule provided by digital multimedia broadcasting (hereinafter referred to as “DMB”), and more particularly, to a method and apparatus for displaying ensembles and a service program schedule provided by DMB so that a user can search for and select a desired service, and selecting, registering, and managing a preferred service according to user's inclination for watching television.

2. Description of the Related Art

In a digital television (TV), a schedule of programs that are currently being broadcasted is given to a television viewer through an electronic program guide (EPG). The EPG presents a schedule of programs televised through respective TV channels according to time sequence, while displaying when programs are televised in a horizontal direction, and displaying information regarding TV channels in a vertical direction. That is, through the EPG, a user can notice a program televised through a particular TV channel at a specific point of time.

FIG. 1 is a view of a screen that displays an EPG that presents a broadcast program schedule. Referring to FIG. 1, programs of each of the TV channels are arranged, categorized by times when the programs are televised in a horizontal direction, and by information regarding the TV channels televising the programs in a vertical direction. In the screen shown in FIG. 1, a user can notice a time when a desired program is televised and the TV channel televising the desired program. For instance, as shown in FIG. 1, an English conversation program is televised through a TV1-2 channel at six in the morning.

FIG. 2 is a flowchart illustrating a conventional method of determining a preferred channel. When a user watches a digital TV, data regarding a selected TV channel and times when the user has watched programs televised through the selected TV channel are stored in a memory installed in the digital TV. In the method illustrated in FIG. 2, data is read from the memory (operation S210), and it is determined whether a number of times that the user has watched a program televised through each of the TV channels for a predetermined length of time is equal to or greater than a predetermined number (operation S220). If the number of times that the user has watched a program televised through a particular TV channel for a predetermined length of time is equal to or greater than the predetermined number, then the particular TV channel is registered as a preferred channel, is marked to be distinguished from other TV channels, and is displayed on a screen (operation S230).

However, in DMB, an EPG or a conventional method of registering a preferred channel are not available. This is because services cannot be sequentially arranged according to a time sequence, since a plurality of services are linked to an ensemble and ensembles and services are transmitted without a predetermined order. Also, a user's preferred channels may be changed according to time. For instance, a TV channel selected frequently at seven in the morning is different from a TV channel selected frequently at nine at night. However, with the conventional method, it is impossible to register preferred channels according to a time sequence.

### SUMMARY OF THE INVENTION

Exemplary embodiments of the present invention provide a method and an apparatus for displaying a service program schedule provided by DMB, categorized by ensembles and services, and for arranging and registering a user's preferred services according to a time sequence.

According to one aspect of the present invention, there is provided a method of displaying a broadcast program schedule provided by digital multimedia broadcasting, the method including displaying ensembles included in the broadcast program schedule in a first window of a screen, and displaying services linked to each of the ensembles in a second window of the screen.

The first and second windows may be obtained by dividing the screen into two parts in either a horizontal direction or a vertical direction.

The first window may further comprise arrow keys which are pressed to display more ensembles on the screen, and the second window may further comprise a button which is pressed to display more services when all of the services cannot be displayed on the second window.

According to another aspect of the present invention, there is provided a method of selecting a service by detecting a broadcast program schedule provided by digital multimedia broadcasting, the method including selecting an ensemble in a first window of a screen that displays ensembles included in the broadcast program schedule, and selecting a service in a second window of the screen that displays services linked to the selected ensemble.

According to yet anther aspect of the present invention, there is provided a method of registering a user's preferred service provided by digital multimedia broadcasting, the method including (a) reading a history of a service that has been watched, and determining whether a period, number of times, and amount of time that the service has been watched are equal to or greater than a predetermined period, number of times, and amount of time; and (b) when the period, number of times, and amount of time of the service are equal to or greater than the predetermined period, number of times, and amount of time, the service is registered as a preferred service.

As discussed above, (a) may include the following: (a1) reading the history of the service, and determining whether the period that the service has been watched is equal to or greater than the predetermined period; (a2) when it is determined in (a1) that the period is equal to or greater than the predetermined period, determining whether the number of times that the service has been watched is equal to or greater than the predetermined number of times; and (a3) when it is determined in (a2) that the number of times is equal to or greater than the predetermined number of times, determining whether the amount of time that the service has been watched is equal to or greater than the predetermined amount of time.

According to still another aspect of the present invention, there is provided an apparatus for managing a preferred service, the apparatus including a database unit which stores service history data regarding histories of services that a user has watched, stores preferred service condition data regarding conditions of a preferred service, and stores preferred service data regarding preferred services; and a determination unit which reads the service history data, applies the preferred service condition data to respective services, determines whether the respective services are preferred services, and stores the result of the determination in the database unit.

The database unit may include a service watching history data storage unit which stores a record of a service that the user has watched; a determination condition data storage unit which stores conditions of a preferred service; and a preferred service data storage unit which stores data regarding a service to be determined as a preferred service.

The preferred service data storage unit may store data regarding preferred services according to time.

### BRIEF DESCRIPTION OF THE DRAWINGS

The above and other aspects of the present invention will become more apparent by describing in detail exemplary embodiments thereof with reference to the attached drawings in which:

FIG. 1 is a view of a screen that displays an electronic program guide (“EPG”) that presents a broadcasting program schedule;

FIG. 2 is a flowchart illustrating a conventional method of determining a preferred channel;

FIG. 3 is a view of a screen that displays ensembles and a service program schedule according to an exemplary embodiment of the present invention;

FIGS. 4A through 4D are reference views illustrating a process of detecting ensembles and a service program schedule, and selecting and viewing a service according to an exemplary embodiment of the present invention;

FIG. 5 is a view of a screen that displays ensembles and a service program schedule according to another exemplary embodiment of the present invention;

FIG. 6 is a view of a screen that displays preferred services selected according to a user's inclination for watching television according to an exemplary embodiment of the present invention;

FIG. 7 is a block diagram of a DMB receiver that provides a user with a screen that displays ensembles and a service program schedule, and decodes and outputs a service selected by the user, according to an exemplary embodiment of the present invention;

FIG. 8 is a block diagram of an apparatus for registering and managing a user preferred service selected according to a user's inclination for watching television, according to an exemplary embodiment of the present invention; and

FIG. 9 is a flowchart illustrating a method of analyzing a user's inclination for watching television and for registering a preferred service according to an exemplary embodiment of the present invention.

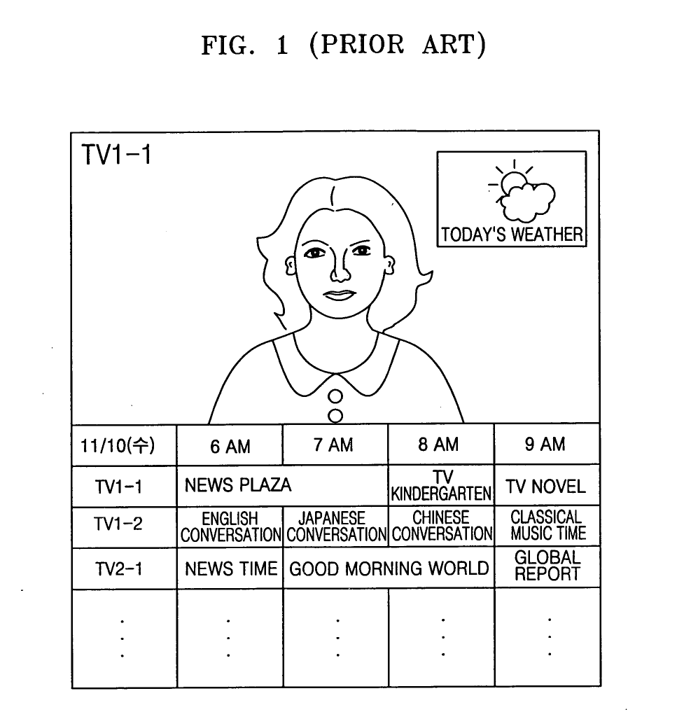

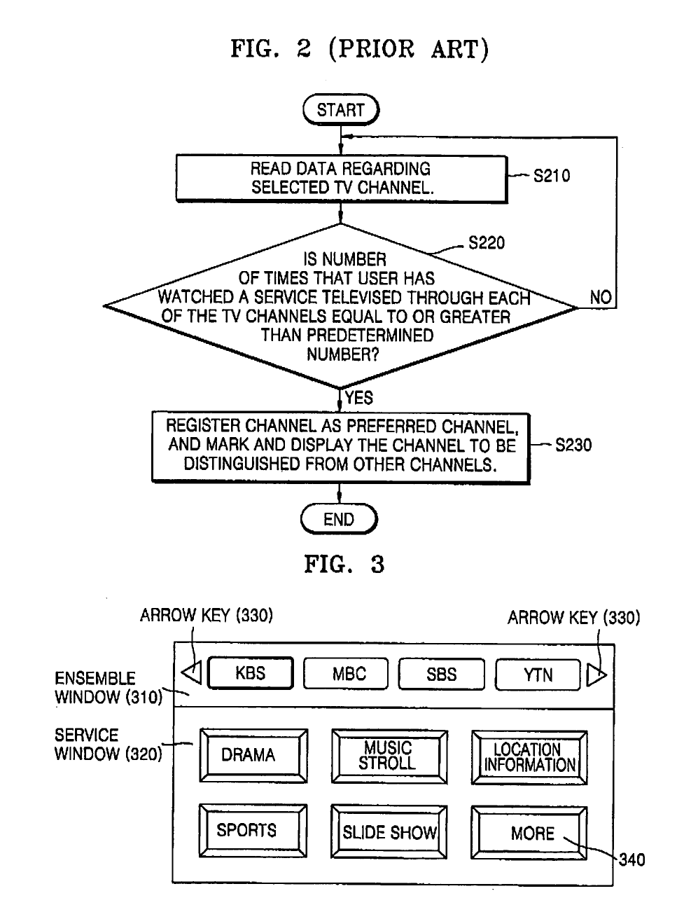

### DETAILED DESCRIPTION OF EXEMPLARY EMBODIMENTS OF THE INVENTION

The various aspects of the present invention will now be described in detail by describing certain exemplary embodiments thereof with reference to the accompanying drawings.

FIG. 3 is a view of a screen that displays ensembles and a service program schedule provided by DMB according to an exemplary embodiment of the present invention. Referring to FIG. 3, the screen includes an ensemble window 310, and a service window 320. The ensemble window 310 displays “KBS”, “MBC”, “SBS”, and “YTN” ensembles that are now broadcasting services. It is possible to detect more ensembles in the ensemble window 310 using right and left arrow keys 330. The service window 320 displays services linked to an ensemble which has been selected on the ensemble window 310. For example, referring to FIG. 3, when the KBS ensemble is selected, “Drama”, “Music Stroll”, “Location Information”, and “Slide Show” are displayed as services linked to the KBS ensemble. If all of the services linked to an ensemble cannot be displayed on the service window 320, the services can be searched for using a “more” button 340.

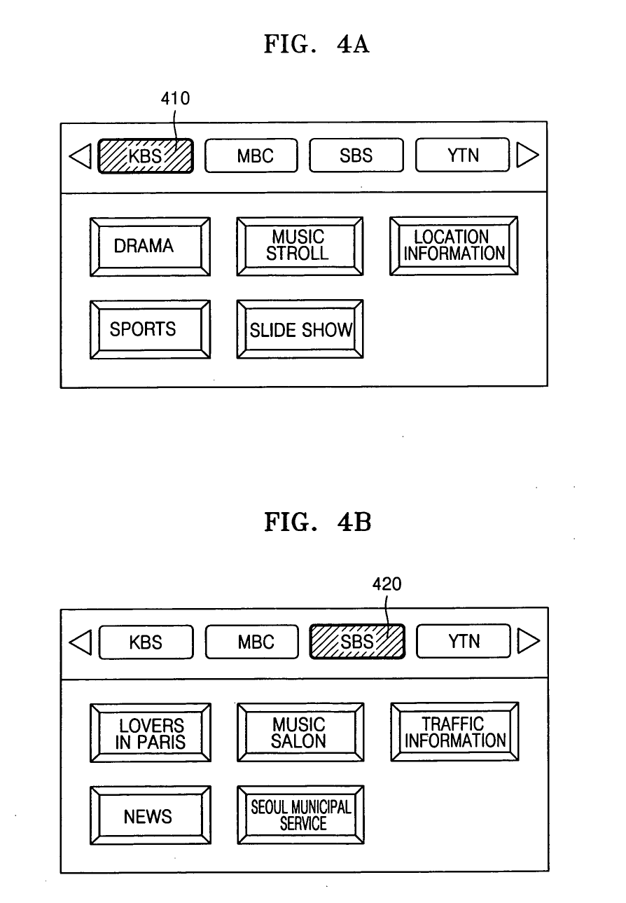

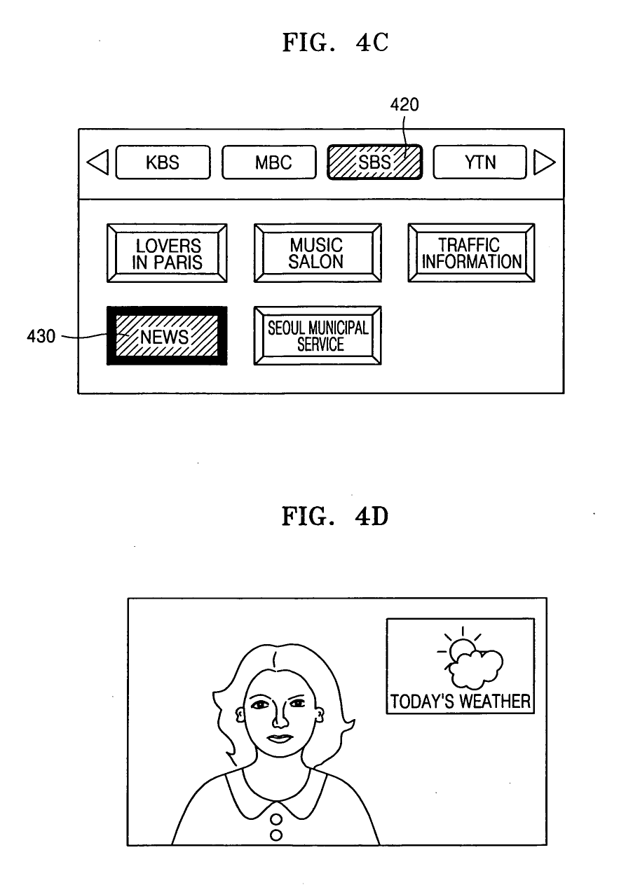

FIGS. 4A, 4B, 4C and 4D are reference views illustrating a process of searching for, selecting, and watching a service on a screen that displays an ensemble and a service program schedule, according to an exemplary embodiment of the present invention. When a user presses a service selection button to check ensembles and services that a DMB receiver is currently receiving, a screen, such as that shown in FIG. 4A, which shows the receiving ensembles and services, is displayed. Then, the user selects a desired ensemble on the screen by pressing a touch screen or a button of the DMB receiver. The selected ensemble is highlighted so that it can be distinguished from the other ensembles. Referring to FIG. 4A, a KBS ensemble 410 is highlighted, and services linked to the KBS ensemble 410 are displayed on a service window. If, for example, the user selects an SBS ensemble 420, as illustrated in FIG. 4B, then “Lovers in Paris”, “Music Salon”, “Traffic Information”, “News”, and “Seoul Municipal Service” are displayed as services. Referring to FIG. 4C, when the user selects the SBS ensemble 420 and “News” service 430, news service is displayed on a screen of the DMB receiver, as illustrated in FIG. 4D.

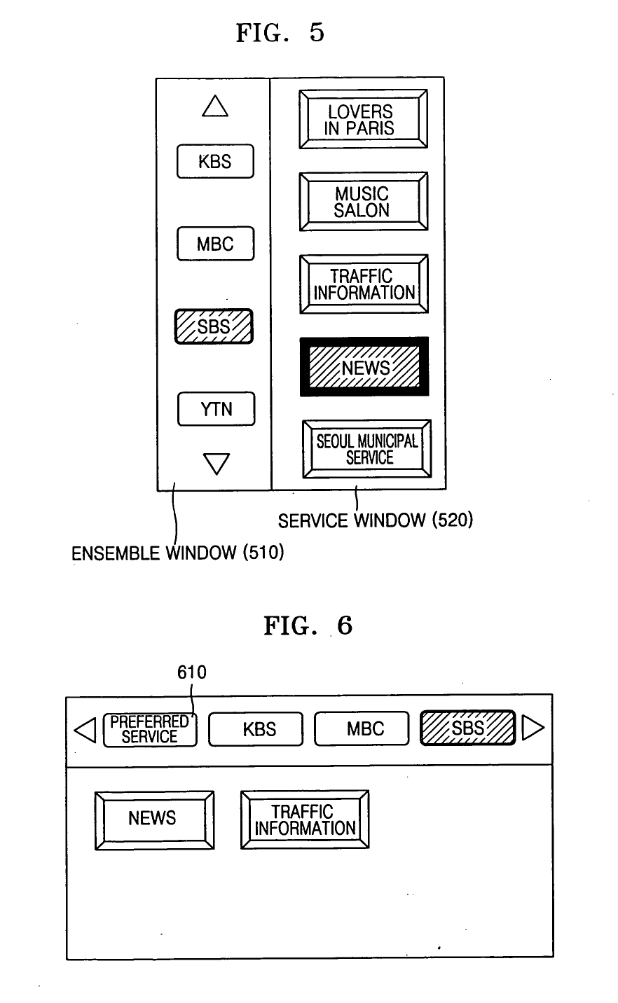

FIG. 5 is a view of a screen that displays ensembles and a service program schedule according to another exemplary embodiment of the present invention. Referring to FIG. 5, the screen is divided into two parts, i.e., an ensemble window 510 and a service window 520, in a vertical direction. A user can select an ensemble on the ensemble window 510 and can select one of the services linked to the selected ensemble. According to an exemplary embodiment of the present invention, it is possible for the user to determine whether the screen will display ensemble and services in a horizontal direction, as shown in FIG. 3, or in a vertical direction, as shown in FIG. 5. In some cases, the ensembles and services that are available may preferably, but not necessarily, be displayed in the vertical direction so as to disclose more parts of a scene of a program that is currently broadcasting.

FIG. 6 is a view of a screen that displays preferred services that are determined according to a user's inclination for watching TV, according to an exemplary embodiment of the present invention. Referring to FIG. 6, a user's preferred services linked to each of the KBS, MBC, and SBS ensembles may be grouped together as a preferred service 610. As shown in FIG. 6, a button for selecting preferred services is displayed on a line of the screen where the ensembles are located, and the preferred services linked to a selected ensemble are displayed on a service window.

A method of registering and managing a user's preferred services according to an exemplary embodiment of the present invention will now be described.

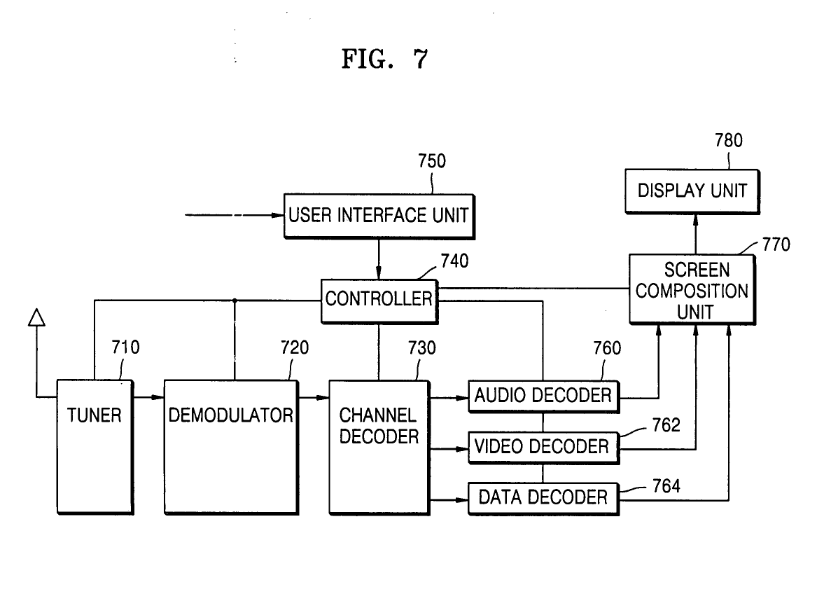

FIG. 7 is a block diagram of a DMB receiver that provides a user with a screen that displays ensembles and a service program schedule, and decodes and outputs a service that is selected by a user. Referring to FIG. 7, the DMB receiver includes a tuner 710, a demodulator 720, a channel decoder 730, a controller 740, a user interface unit 750, an audio decoder 760, a video decoder 762, a data decoder 764, a screen composition unit 770, and a display unit 780.

When an orthogonal frequency division multiplexing (OFDM) modulated signal is input to the tuner 710, the OFDM modulated signal is demodulated and transformed into a digital audio broadcast (DAB) transmission frame by the demodulator 720. The channel decoder 730 parses fast information channel (FIC) data contained in the DAB transmission frame and generates a service list. The FIC data contains service encoding parameters and packetizing information. Therefore, the FIC data is parsed to present services to be provided and the way that data constituting each of the services was encoded and packetized. The controller 740 informs the channel decoder 730 of the type of service whose data to be decoded. A desired service may be selected and input to the controller 740, using the user interface unit 750, which may be, for example, a touch screen or a button.

The controller 740 sends a command, which instructs related services to be decoded, to the audio decoder 760, the video decoder 762, and the data decoder 764, respectively. Then, the audio decoder 760, the video decoder 762, and the data decoder 764 respectively output decoded audio, video, and data services to the screen composition unit 770. Next, the screen composition unit 770 generates a screen that displays ensembles and a service program schedule, and outputs it to the display unit 780 so that a user can view it, under the control of the controller 740, i.e., in response to a control signal generated by the controller 740.

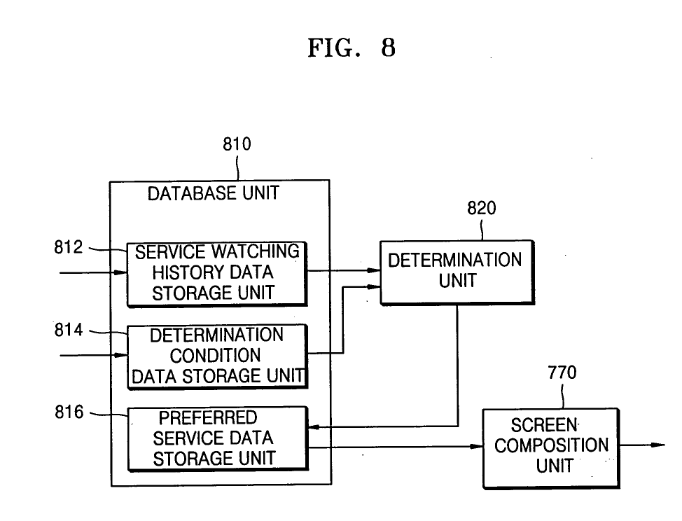

FIG. 8 is a block diagram of an apparatus for registering and managing a user's preferred service selected according to a user's inclination for watching TV, according to an exemplary embodiment of the present invention. Referring to FIG. 8, the apparatus includes a database unit 810 and a determination unit 820. The database unit 810 includes a service watching history data storage unit 812, a determination condition data storage unit 814, and a preferred service data storage unit 816. The service watching history data storage unit 812 stores all of histories regarding services that a user has selected and watched for a predetermined length of time. That is, the service watching history data storage unit 812 stores data regarding the kinds of ensembles and services that the user has selected, and the time and period that the user has watched a particular service. Accordingly, the data stored in service watching history data storage unit 812 specifies a period, a number of instances, and times that a service has been watched. The determination condition data storage unit 814 stores conditions of a preferred service. The conditions may prescribe that a service that has been watched for 5 or more minutes at a time and for 100 or more hours in a month is a preferred service. The conditions may be variously determined by the user. The conditions are categorized and stored according to a period, a number of instances, and the times that a service has been watched.

The preferred service data storage unit 816 stores preferred service data that specifies the services to be determined as preferred services. Further, the preferred service data are stored according to time. Since a user may have different preferred services at 8 am, 1 pm, and 9 pm, for example, the preferred services may be categorized and their data may be stored according to time, e.g., at intervals of hours. However, the possible criterion for categorizing preferred services is not limited, that is, the user can use various criteria.

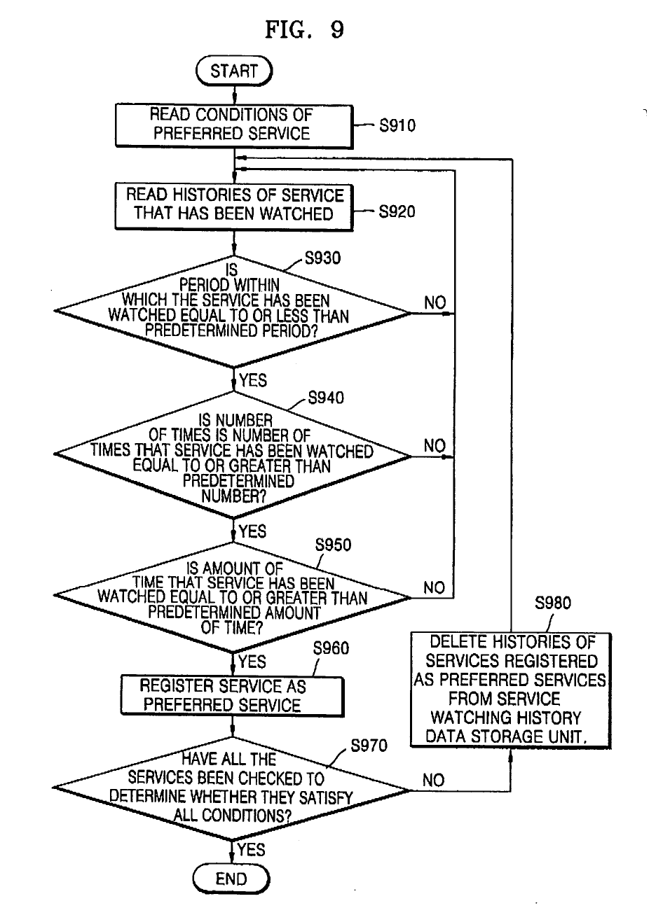

The determination unit 820 reads the conditions from the determination condition data storage unit 814, and detects a preferred service that satisfies the conditions based on the histories regarding services stored in the service watching history data storage unit 812. A method of searching for a preferred service that satisfies the conditions will be described below with reference to FIG. 9. If the preferred service is detected, the data regarding the preferred service is stored in the preferred service data storage unit 816. When the user presses a button for selecting a preferred service, the data regarding the stored preferred service is then transmitted to the screen composition unit 770.

FIG. 9 is a flowchart illustrating a method of analyzing a user's inclination for watching TV and for registering a preferred service according to an exemplary embodiment of the present invention. Referring to FIG. 9, when a command that instructs data regarding a preferred service to be updated, conditions of a preferred service are read from the determination condition data storage unit 814 as shown in FIG. 8 (operation S910). Next, the history of a service that has been watched is read from the service watching history data storage unit 812 (operation S920). Next, whether the service satisfies a watching period condition, which is one of the read conditions, is determined (operation S930). That is, the history of the service is read from the service watching history data storage unit 812 to determine whether the service was watched at least once within a predetermined period of time, e.g., a week, 15 days, or a month. If the service satisfies the watching period condition, whether the service satisfies a watching number condition within the predetermined period of time is determined (operation S940). For instance, whether the service was watched ten times within a month is determined. In operation S940, cases where the service has been watched for five or more minutes at a time are considered so as to exclude cases where the service has been watched for a very short time to detect a desired service.

If the service satisfies the watching number condition, whether the service satisfies a watching time condition is determined (operation S950). For instance, whether the service was watched for 100 or more hours within a month is determined. When the service satisfies the watching time condition, the service is registered as a preferred service (operation S960). If the service does not satisfy the conditions checked in operations S930 through S950, the history of another service that has been televised is read, and the above operations S910 through S950 are performed again. After operation S960, it is determined whether all of the services have been checked to determine whether they satisfy all the conditions (operation S970). If there is no service to be checked, the method is completed. If a service to be checked remains, the history of a service registered as a preferred service is deleted from the service watching history data storage unit 812 (operation S980).

As described above, according to the exemplary embodiments of the present invention, ensembles and a service program schedule provided by DMB are displayed for a user to easily view and select them. Also, consistent with exemplary embodiments of the present invention more information can be displayed on a screen with a limited size. Further, a user's preferred services are registered and managed according to time, thereby more precisely reflecting user's inclination for watching TV.

The present invention can be embodied as a computer program. Codes and code segments of the computer program may be easily derived by computer programmers in the arts. The computer program may be stored in a computer readable medium. When the computer program is read and executed in a computer, a method of registering and managing a preferred service according to the present invention is performed. The computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of displaying a broadcast program schedule provided by digital multimedia broadcasting, the method comprising:
displaying ensembles included in the broadcast program schedule in a first window of a screen; and
displaying services linked to each of the ensembles in a second window of the screen.

2. The method of claim 1, wherein the first and second windows are obtained by dividing the screen into two parts in a horizontal direction or a vertical direction.

3. The method of claim 2, wherein the first window further comprises arrow keys which are operable to display more ensembles on the screen, and
the second window further comprises a button which is operable to display more services when all of the services cannot be displayed on the second window.

4. A method of selecting a service by detecting a broadcast program schedule provided by digital multimedia broadcasting, the method comprising:
selecting an ensemble displayed in a first window of a screen that displays ensembles included in the broadcast program schedule; and
selecting a service displayed in a second window of the screen that displays services linked to the selected ensemble.

5. The method of claim 4, wherein the ensemble is selected using a touch screen, or an arrow key which is operable to search for a desired ensemble.

6. The method of claim 4, wherein the first and second windows are generated by dividing the screen into two parts in a horizontal direction or a vertical direction.

7. A method of registering a user's preferred service provided by digital multimedia broadcasting, the method comprising:
reading a history of a service that has been watched;
determining whether a period within which the service has been watched is equal to or less than a predetermined period;
determining whether a number of times that the service has been watched is equal to or greater than a predetermined number of times;
determining whether an amount of time that the service has been watched is equal to or greater than a predetermined amount of time; and
if the period within which the service has been watched is equal to or less than the predetermined period, the number of times that the service has been watched is equal to or greater than the predetermined number of times, and the amount of time of that the service has been watched is equal to or greater than the predetermined amount of time, the service is registered as a preferred service.

8. A method of registering a user's preferred service provided by digital multimedia broadcasting, the method comprising:
reading a history of a service that has been watched;
determining whether a period within which the service has been watched is equal to or less than a predetermined period;
if it is determined that the period within which the service has been watched is equal to or less than the predetermined period, determining whether a number of times that the service has been watched is equal to or greater than a predetermined number of times; and
if it is determined that the number of times that the service has been watched is equal to or greater than the predetermined number of times, determining whether an amount of time that the service has been watched is equal to or greater than a predetermined amount of time.

9. The method of claim 8, wherein the history of the service is read to determine whether the service has been selected and watched at least once within the predetermined period.

10. The method of claim 8, further comprising, if it is determined that the period within which the service has been watched is equal to or less than the predetermined period, determining whether the service has been watched the predetermined number of times within the predetermined period.

11. The method of claim 8, further comprising if it is determined that the number of times that the service has been watched is equal to or greater than the predetermined number of times, determining whether the amount of time that the service has been watched within the predetermined period is equal to or greater than the predetermined amount of time.

12. The method of claim 7, further comprising, if the period within which the service has been watched is greater than the predetermined period, the number of times when the service has been watched is less than the predetermined number of times, and the amount of time that the service has been watched is less than the predetermined amount of time:
reading a history of a next service that has been watched;
determining whether a period within which the next service has been watched is equal to or less than the predetermined period;
determining whether a number of times that the next service has been watched is equal to or greater than the predetermined number of times;
determining whether an amount of time that the next service has been watched is equal to or greater than the predetermined amount of time.

13. An apparatus for managing a preferred service, the apparatus comprising:
a database unit which stores service history data regarding histories of services that a user has watched, stores preferred service condition data regarding conditions of a preferred service, and stores preferred service data regarding preferred services; and
a determination unit which reads the service history data, applies the preferred service condition data to respective services, determines whether the respective services are preferred services, and stores result of the determination in the database unit.

14. The apparatus of claim 13, wherein the database unit comprises:
a service watching history data storage unit which stores a record of a service that a user has watched;
a determination condition data storage unit which stores conditions of a preferred service; and
a preferred service data storage unit which stores data regarding a service to be determined as a preferred service.

15. The apparatus of claim 14, wherein the conditions stored in the determination condition data storage unit can be changed by the user.

16. The apparatus of claim 14, wherein the preferred service data storage unit stores data regarding preferred services according to time.

17. A computer readable recording medium for storing a program that executes a method of displaying a broadcast program schedule provided by digital multimedia broadcasting using a computer, the method comprising:
displaying ensembles included in the broadcast program schedule in a first window of a screen; and
displaying services linked to each of the ensembles in a second window of the screen.
